(19) United States
(12) Patent Application Publication
(10) Pub. No.: US 2026/0317999 A1
(43) Pub. Date: Oct. 15, 2026

(54) SYSTEM FOR DIGITAL TRANSFER PRINTING ON LIGHT OR DARK TEXTILE SUBSTRATES AND TRANSFER METHOD

(71) Applicant: SUMIPRINT QUIMICA Y COLOR S.A.S, Medellin (CO)

(72) Inventors: Hugo Alberto ÁLVAREZ GONZÁLEZ, Bogotá (CO); Julio Alberto ÁLVAREZ PÉREZ, Medellin (CO)

(21) Appl. No.: 19/480,940

(22) PCT Filed: Apr. 5, 2024
(86) PCT No.: PCT/IB2024/053358

§ 371 Date: Nov. 3, 2025

(30) Foreign Application Priority Data
Dec. 20, 2023 (CO) NC2023/0018005

(51) Int. Cl. D06P 5/24; B41J 2/005; B41J 2/01; B41J 2/175; B41J 2/21; B41J 11/00; B41M 5/025; B41M 7/00; C09D 11/322; C09D 11/38; C09D 11/54; D06P 3/60

(52) U.S. Cl. CPC D06P 5/007; B41J 2/0057; B41J 2/175; B41J 2/2103; B41J 2/2114; B41J 11/0015; B41M 5/0256; B41M 7/0054; C09D 11/322; C09D 11/38; C09D 11/54; D06P 3/60; B41J 2002/012

(57) ABSTRACT

A system for printing and transferring digital images onto different substrates, especially textiles, on light or dark backgrounds, with unprecedented effects, very good coverage, soft hand feel, high definition, good elongation, and excellent wash resistance is provided. To achieve this result, the system includes four elements: transfer paper; digital inkjet printing inks (CMYK); transparent base ink; and colored/effect powder adhesive. Additionally, the present invention includes the process for transferring images onto the articles.

### FIELD OF THE INVENTION

The present invention relates to the field of transferring images onto articles, and more specifically to a system for the printing and transfer of digital images onto different substrates—particularly textiles—on light or dark backgrounds, with very good coverage, soft hand, high definition, good elongation, and excellent wash resistance. To achieve this result, the system comprises four elements: transfer paper; digital inkjet printing inks (CMYK); a transparent base ink; and colored and effect powder adhesive. Additionally, the present invention includes the process for transferring said images onto said articles.

### BACKGROUND OF THE INVENTION

Given the significant developments in digitization, the textile printing industry continues to seek ways to leverage digital technology in both direct and indirect printing. Among the most developed and digitally employed textile printing techniques are:
Sublimation: an indirect printing method in which images are digitally printed with sublimable disperse dye-based inks onto a paper, and then transferred by heat and pressure to textiles. However, this method is only applicable to light-colored fabrics with high polyester content.
Direct-to-Garment (DTG): a direct printing method in which a digital printhead or printer applies the ink directly to the garment without the need for intermediate supports such as papers or heat-transfer vinyls. Its main limitations are the high cost of inks required for this technique, the slow printing process, and the necessary pretreatment of the textile to be printed.
Printed and unprinted heat-transfer textile vinyls: an indirect printing method wherein a vinyl material includes an adhesive that activates upon heating, adhering to the fabric. This vinyl can be digitally printed and cut into designs, shapes, and letters. The main limitations are the slowness and technical complexity of the process, since generating transferable images requires manually removing the portions that are not part of the design.
Direct-to-Film (DTF): an indirect method in which an image is digitally printed onto a special synthetic substrate (carrier). A raster image processor (RIP) manages the printing order of color inks and an additional white ink so that the printed image colors are covered with an overlaid layer of white ink. After spreading and curing a colorless powder adhesive over the printed image, the same image is transferred onto a light or dark textile substrate. In this technique, clogging of piezoelectric printheads in the digital printers is common, leading to frequent machine stoppages and reduced printhead lifespan. This is mainly because the white backing inks used to achieve coverage during transfer have a strong tendency to sediment and form clumps: they must be formulated with resins and low viscosity to be jettable, and they incorporate inorganic white pigments with high sedimentation tendency (high specific gravity). To counteract these problems, the technique calls for routine cleaning protocols for the piezoelectric printheads and for white-ink recirculation systems in the printers; nevertheless, these lead to high ink consumption, lower productivity, and considerably higher costs.

Accordingly, while DTF is one of the closest techniques to the present invention, the present invention overcomes the problems inherent in DTF. Within the prior art, there are numerous disclosures of related inventions, including, for example, US20200347253A1, which discloses an article—such as a garment made from textile fiber—that bears a transferred printed image while preserving as much as possible its essential properties, such as texture; it also teaches a manufacturing process for the article; a transfer material to carry out the transfer; and a material to obtain the transfer material. The transfer material is produced by forming a hot-melt adhesive layer portion in specific post-print regions on a designated face of a substrate, so that it can be removed from the substrate, forming a printed image layer to display a desired image in the adhesive layer portion by plate-less printing. The adhesive layer portion and the printed image layer of the transfer material are heated and pressed against the target article to achieve fusion-bonding of the adhesive layer portion with the target article, thus fixing the adhesive layer portion and the printed image layer to the target article upon cooling.

However, that invention does not mention selective transfer to the substrate: the entire adhesive film is transferred. Where there is no image, the transferred film is transparent. Moreover, because the film is transparent, the transfer is not applicable to dark substrates. That document also indicates that the transfer occurs by fusion and not by using a powder adhesive that adheres to the substrate, wherein said powder adhesive preferably includes white color and effects, i.e., is non-transparent.

Another related disclosure is JP5656168B2, which refers to a printing method, a transfer material, and an inkjet discharge device, and more particularly to a transfer printing method and a transfer material and inkjet discharge device used in such method.

However, that invention states that, at the moment the image is printed, UV-curable inks coat areas that do not belong to the design, so that during transfer, the coated areas that do not belong to the image are not transferred to the substrate—a concept that departs from the present invention. In that invention, the adhesive resides in the substrate on which the image is printed, not as a powder that coats the freshly printed wet image layer.

U.S. Pat. No. 11,577,536B2 allows an image to be formed on a transfer medium comprising a hydrophilic adhering agent. Any portion of the image that is dimensionally insufficient to permanently adhere the image to the receiving substrate is determined, and a colorless liquid ink comprising water is applied to cover and surround that portion. Upon heating during transfer, the water swells the image layer and the hydrophilic adhesive becomes sufficiently tacky to permanently adhere the image to the receiving substrate.

However, in that document the inks are dye-based; no aqueous, pigment-based inks are used that are printed through piezoelectric printheads. Adhesion to the transfer substrates is based on an increase in tack due to wetting produced by the inks when the carrier substrate is printed. Because dyes are used, the method only works for transfers onto light substrates. There is no powder adhesive among its elements to provide effects or coverage by coating the freshly printed wet layer. In contrast, in the present system, the adhering resin is in the support on which the image is printed.

U.S. Pat. No. 9,399,362B1 relates to a method for transferring an image to an article using a heat transfer assembly having a support layer and an image transfer layer, where the image transfer layer contains a binder, an ink receptor, and a hydrophilic film-forming blocking agent. When an aqueous ink composition is used to print an image on the top surface of the transfer assembly, the blocking agent is altered in the imaged areas but not in the non-imaged areas, so that when the image is transferred to a substrate by heat and pressure, substantially all of the binder in the non-imaged areas remains in the transfer assembly.

However, that invention requires that the carrier coating be at least two layers thick. The outermost layer serves as a blocking agent for the carrier coating during transfer to the desired substrate. Only the carrier coating in areas that are part of the design is transferred. In the areas where the aqueous ink—whether pigment or dye—lands, the blocking layer dissolves and the ink is absorbed by an inner layer containing a hot-melt resin.

US20230118044A1 teaches a process for producing a digitally printed heat transfer, comprising: (1) obtaining a substrate having a release layer; (2) applying a primer suitable for electrophotographic toner to the release layer; (3) digitally printing electrophotographic toner to define a graphic within a defined region of a substrate that includes both printed and unprinted areas within that region; (4) digitally printing a tacky viscoelastic binder corresponding to the printed areas of the digitally printed graphic; (5) applying a polyurethane powder adhesive to the defined region; (6) removing loose powder adhesive that does not adhere to the defined regions of the graphic; and (7) fusing and bonding the adhesive to the digitally printed graphic. The binder precisely fixes the powder adhesive to the printed graphic. The result is then cooled to set the image for use as a heat transfer.

However, that invention is based on an electrophotographic toner system; it does not use aqueous, pigment-based inks printed through piezoelectric printheads. Additionally, the carrier support consists of multiple coating layers. It is laser printing, i.e., it does not use piezoelectric printheads, and thus it does not use aqueous digital inks.

Finally, U.S. Pat. No. 8,350,880 relates to a heat image transfer system and a method of use. The system includes a heat transfer sheet and an activating ink. The sheet and the activating ink are specially formulated so that only the areas of the sheet over which the ink has been printed become adhesive under heat-transfer conditions. This effect can be achieved by designing the sheet to include an ink-receptive coating whose melting temperature is higher than that typically encountered during normal heat-transfer conditions and formulating the activating ink to include a plasticizer that, upon printing onto the ink-receptive coating, reduces its melting temperature sufficiently to bring it into the typical heat-transfer temperature range.

However, that patent does not include, among its components, a colored/effect powder adhesive that is spread over the printed image on the carrier support so that the transferred images achieve coverage on dark textile substrates or exhibit a wide variety of effects.

From the prior art, it is clear that the problems to be solved include providing a digital image transfer method that does not use white digital backing inks with a strong tendency to sediment and clump, and that includes colored/effect powder adhesive that, in addition to providing the white color to the transferred image, offers various effects—such as metallic (gold, silver, etc.), fluorescent, pearlescent, puff (chemical blowing agents or expandable microspheres), migration-control agents, among others—and that enables selective image transfer. In particular, the selective transfer of the image to the textile substrate is based on hot-melting the powder adhesive that is spread over the design printed on the carrier support and on selectively plasticizing thermoplastic resins present in the coating, thanks to the application of a transparent base ink layer over the image to be transferred at the time of digital printing (selective transfer of the carrier coating). A surprising technical effect of this invention is the ability to produce digitally printed images with wholly novel and unprecedented effects. Additionally, technical problems are overcome by eliminating white digital inks that were previously necessary to provide coverage on textile substrates.

Accordingly, there is a need in the art for a digital transfer printing system on light or dark textile substrates that includes a colorless transparent base ink that is digitally printed simultaneously with the CMYK color inks onto a coated paper, and is then covered with a powder adhesive that is melted for transfer, wherein said transparent base is a sediment-free fluid ink that avoids clogging of printer heads while interacting with the transfer paper to perform a selective transfer, and wherein the powder adhesive coating includes a composition that favors transfer of the image printed on the coated paper to dark or light textile substrates or to other materials to which the powder adhesive exhibits affinity (e.g., non-wovens, wood, cardboard, PVC tarpaulins), while also ensuring elasticity and wash resistance.

### BRIEF DESCRIPTION OF THE INVENTION

The present invention provides a new indirect digital printing method preferably for printing onto textile substrates. By applying different principles and elements, it offers an original approach to eliminate the disadvantages of the techniques described above and to generate novel and unprecedented colors and effects in printed images. The elements include: (i) a transparent base ink that is a colorless digital printing ink which coats both the areas where the image colors CMYK (cyan, magenta, yellow, and black) are printed as well as the design areas reserved for color or effect to be provided by a powder adhesive subsequently added to the printed image. This is achieved with a raster image processor (RIP) that manages the printing order of CMYK inks and the colorless ink. The transparent base ink is characterized by the absence of the inorganic white pigments mentioned in DTF printing, thereby avoiding sedimentation issues that cause piezoelectric printhead clogging. (ii) A colored/effect powder adhesive, which becomes trapped over the entire design area when it is spread onto the freshly printed wet transparent base layer (FIG. 3). This adhesive provides color, coverage, elasticity, adhesion, and special effects on the textile substrate to which the image is transferred. (iii) A coated transfer paper (FIG. 1), designed to receive images with pigment-type digital printing inks, enabling those images to be transferred to a textile substrate through a receptor base.

In this way, the present printing system and process allow images to be transferred onto textile substrates made of synthetic or natural fibers, light or dark, with perfectly defined contours, elongation, faithful tone, wash and rub resistance required in garments, soft hand, and novel, unprecedented colors and effects (FIG. 7).

### DESCRIPTION OF THE FIGURES

FIG. 1 shows the transfer paper (1) of the present invention.

FIG. 2 shows the transfer paper (1) onto which the transparent base ink (3) has been digitally printed, overlying the areas of the image printed with CMYK colors and directly wetting the transfer paper in the areas reserved for the white color of the image (123), which may also be understood as areas reserved for their color or effect to be provided by the colored/effect powder adhesive according to the printed image design.

FIG. 3 shows the colored/effect powder adhesive (4) spread over the freshly printed wet transparent base ink layer (3), in accordance with the present invention.

FIG. 4 shows the dry-to-the-touch film (34) composed of the colored/effect powder adhesive (4) and the transparent base ink (3) after the curing process, in accordance with the present invention.

FIG. 5 shows the transfer method onto a substrate using a heat press (5), in accordance with the present invention.

FIG. 6 shows the coating areas of the paper that are transferred to the textile substrate corresponding to the image areas printed in CMYK colors and to the areas of the image corresponding to the white color (123)—which may also be understood as areas reserved for color or effect to be provided by the colored/effect powder adhesive according to the printed image design—as well as the coating areas that are not transferred to the textile substrate and do not form part of the transferred image.

FIG. 7 shows the final arrangement of the transferred film on the textile substrate, where the CMYK colors of the image are surrounded by a hot-melt layer composed of the paper coating, the colored/effect powder adhesive, and the colorless digital printing ink.

FIG. 8 shows the transfer result, where images are transferred to textile substrates made of synthetic or natural fibers, light or dark, with perfectly defined contours, elongation, faithful tone, resistance, soft hand, and novel effects, in accordance with the present invention.

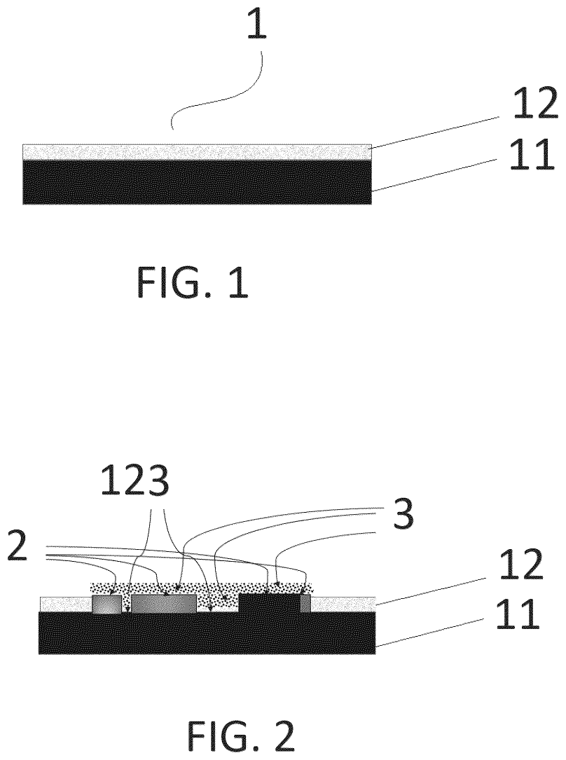

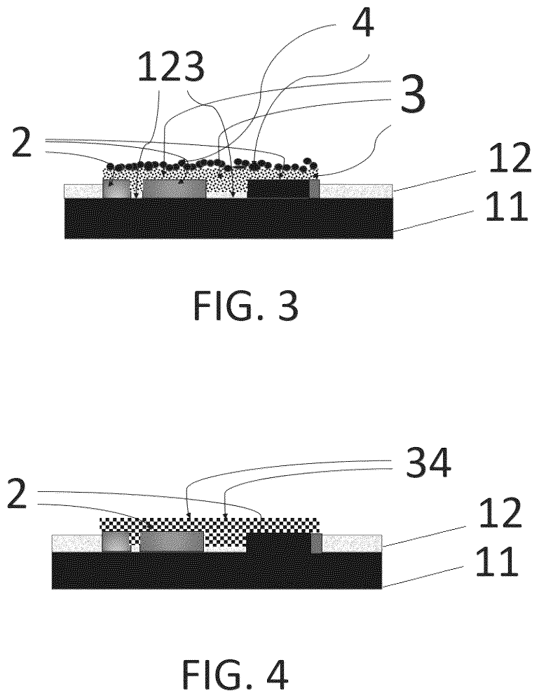

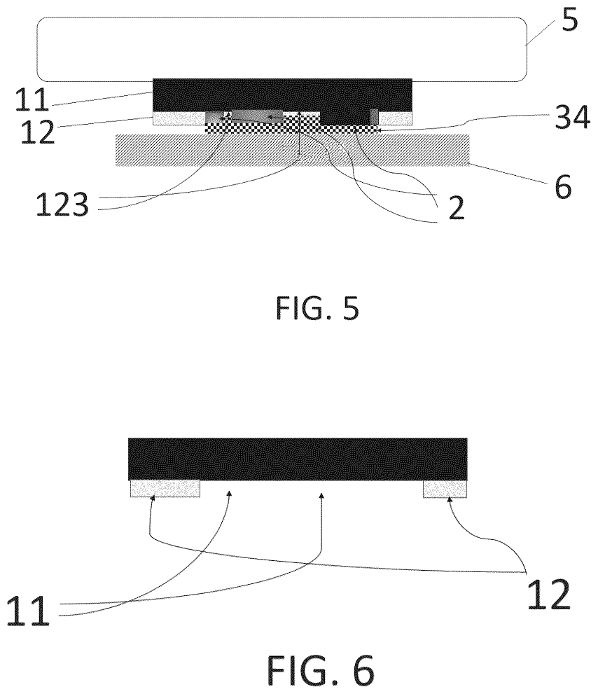

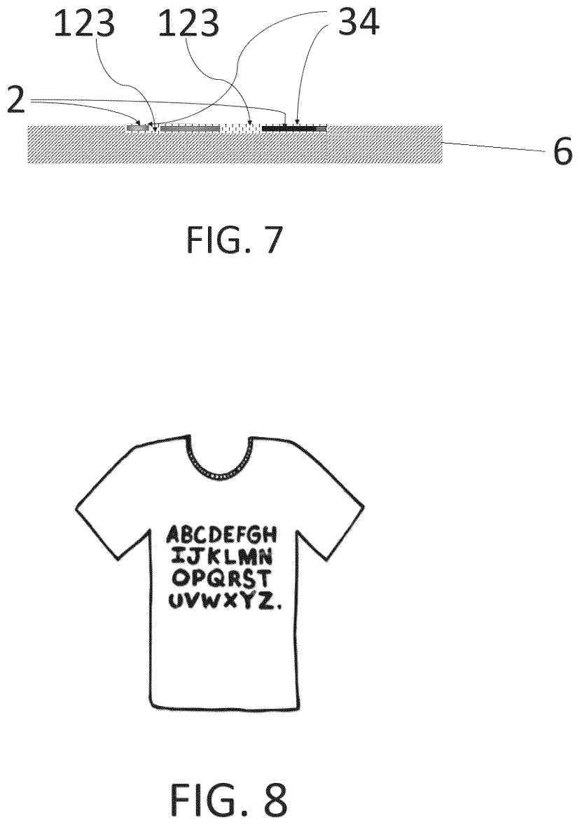

### DETAILED DESCRIPTION OF THE INVENTION

The invention relates to a digital transfer printing system for light or dark textile substrates characterized by comprising: a transfer paper (1); digital inkjet printing inks (2); a transparent base ink (3); and a colored/effect powder adhesive (4), where the transfer paper includes a coating layer (12). The paper (1) receives a digital print performed via RIP software that manages, in an inkjet printer, the order of ink deposition such that both the image areas where the CMYK colors (cyan, magenta, yellow, and black) are printed and the image areas reserved for white (i.e., reserved for color/effect to be provided by the colored/effect powder adhesive) are overlaid by a layer of the transparent base ink. The freshly printed wet layer subsequently receives the colored/effect powder adhesive (4). Heat is then applied to the printed image to melt the powder adhesive retained on the image at temperatures between 160 °C and 180 °C for 10-40 seconds, forming a cured film. The retained powder adhesive melts to yield a dry-to-the-touch film (34) on the printed image, enabling storage or subsequent transfer of the image to a substrate, preferably a textile.

### Transfer Paper

The transfer paper (1) of the present invention is a coated paper for transferring images onto substrates—preferably textiles—featuring a coated layer compatible with digital printing inks. An example of such transfer paper is taught in CO-NC2019/0008859. Thus, the paper should include elements such as water-soluble polymers, fillers, resins or thermoplastic polymers, binder polymers, release agents, and preservatives, which, together with the other elements of the present digital transfer printing system, enable suitable image transfer.

### Digital Inkjet Color Inks

The digital inkjet printing inks (2) used herein are pigment-based and are specially formulated to minimize printhead clogging. They are characterized by the absence of resins among their ingredients—since film-forming resins increase the likelihood of nozzle blockage. These inks comprise deionized water between 20% and 80%; organic pigments between 3% and 15%; preservatives between 0.1% and 0.2%; drying retarders between 5% and 30%; and humectants between 1% and 5%.

The deionized water preferably has a maximum conductivity of 75 μS (microsiemens) to avoid corrosion-induced deterioration of piezoelectric printheads.

The organic pigments may include, for example, phthalocyanines, quinacridones, monoazo pigments, diarylide pigments, pyrazolone pigments, disazo-condensation pigments, and polycyclic pigments. In dispersion, particle size is <200 nm, preferably <80 nm.

Drying retarders can be selected from water-soluble materials such as ethylene glycol; 1,3-propanediol; 1,4-butanediol; 1,4-cyclohexanedimethanol; 1,5-pentanediol; 1,6-hexanediol; 1,8-octanediol; 1,2-propanediol; propane-1,2,3-triol (glycerol); 1,2-butanediol; 1,3-butanediol; 2,3-butanediol; diethylene glycol; triethylene glycol; tetraethylene glycol; and polyethylene glycols of average molecular weight 200, 300, 400, 600, 900, 1000, 1500, and 2000.

Preservatives can be selected from chloromethylisothiazolinone derivatives, which have a broad activity spectrum against Gram-negative and Gram-positive bacteria and fungi (yeasts and molds), contain no formaldehyde, and are FDA-approved in adhesives and paper coatings due to low toxicity.

Humectants can be selected from ethoxylated acetylenic diols (e.g., 2,5,8,11-tetramethyl-6-dodecin-5,8-diol ethoxylated); sulfosuccinates (e.g., sodium dioctyl sulfosuccinate, sodium dibutyl sulfosuccinate, sodium diisopropyl sulfosuccinate); siloxane-based gemini surfactants; fluorinated surfactants; organosilicones; and pyrrolidone-based surfactants (e.g., 1-octyl-2-pyrrolidone). By reducing surface tension, humectants improve wetting of the coated transfer paper and help control droplet formation at the printheads.

### Transparent Base Ink

The transparent base ink (3) is a colorless water-based ink (either 100% aqueous or an oil-in-water emulsion). It comprises: deionized water between 20% and 80% by weight; drying retarder between 10% and 40% by weight; pH stabilizer between 0.5% and 4% by weight; preservatives between 0.1% and 3% by weight; emulsifiers between 0.5% and 4% by weight; humectants between 2% and 20% by weight; optical brightener between 0.5% and 3% by weight; and plasticizers between 5% and 40% by weight.

The deionized water preferably has a maximum conductivity of 75 μS to avoid corrosion-induced deterioration of piezoelectric printheads.

Drying retarders are selected from water-soluble materials such as ethylene glycol; 1,3-propanediol; 1,4-butanediol; 1,4-cyclohexanedimethanol; 1,5-pentanediol; 1,6-hexanediol; 1,8-octanediol; 1,2-propanediol; propane-1,2,3-triol; 1,2-butanediol; 1,3-butanediol; 2,3-butanediol; diethylene glycol; triethylene glycol; tetraethylene glycol; and polyethylene glycols (Mw 200-2000).

pH regulators are selected from sodium hydroxide, potassium hydroxide, sodium carbonate, sodium bicarbonate, triethanolamine, 2-amino-2-methyl-1-propanol, diethanolamine, and ethanolamine, which additionally contribute emulsifying and wetting properties. The target pH is 8-9.

Preservatives are selected from chloromethylisothiazolinone derivatives for the reasons stated above.

Emulsifiers may include nonionic emulsifiers such as glycerol esters (e.g., glyceryl monostearate, glyceryl stearate citrate) that form oil-in-water emulsions; fatty alcohols with 3, 4, 6, 8, or 10 ethoxylation units (e.g., laureth-10); polyglycerides (polymers of glycerin and fatty acids) that can form both oil-in-water and water-in-oil emulsions depending on polymerization; fatty acid alkanolamides (e.g., lauryl diethanolamide, oleyl diethanolamide); ethoxylated amines and amides; anionic emulsifiers such as linear and branched sodium alkylbenzenesulfonates, linear and branched alkyl sulfates, and linear and branched alkyl ethoxy sulfates; and sucrose fatty acid esters (e.g., sucrose polystearate), which form oil-in-water emulsions and impart emollient/conditioning properties.

Humectants may be chosen from ethoxylated acetylenic diols; sulfosuccinates; siloxane-based gemini surfactants; fluorinated surfactants; organosilicones; and pyrrolidone-based surfactants (e.g., 1-octyl-2-pyrrolidone). By reducing surface tension, they improve wetting of the coated transfer paper and help control droplet formation and coalescence in the printed image.

Optical brighteners are selected from triazine-stilbene types (e.g., 4,4′-diamino-2,2′-stilbene disulfonic acid), coumarins (e.g., triazine phenyl coumarin, benzotriazole phenyl coumarin, naphthotriazole phenyl coumarin), bis-benzoxazoles, imidazolines, diazoles, triazoles, and biphenyl stilbenes. Because this ink is transparent, an optical brightener is included so that periodic nozzle checks become visible under a UV lamp.

To comply with textile-industry regulations regarding phthalate limits, plasticizers are selected from aliphatic dicarboxylic acid esters (e.g., dibutyl adipate, dibutoxyethyl adipate, di(2-ethylhexyl) adipate, di-isooctyl adipate, diisodecyl adipate, dibutyl sebacate, butyl benzyl adipate, dioctyl sebacate), citric acid esters (e.g., triethyl citrate, tributyl citrate, acetyl tri-n-butyl citrate, acetyl tri-n-hexyl citrate), alkylsulfonic acid esters with phenols, benzoates (e.g., propylene glycol dibenzoate, dipropylene glycol dibenzoate), terephthalates (e.g., di-2-ethylhexyl terephthalate, DOTP), and trimellitates (e.g., tri-2-ethylhexyl trimellitate, TOTM; tri-isooctyl trimellitate, TIOTM; tri-isononyl trimellitate, TINTM).

One function of the overlaid transparent base layer (3) is to increase the total deposited ink on the digitally printed image so that it serves as a wet receptor layer for the colored/effect powder adhesive. Specifically, with digital color ink deposition on the coated paper in the range of 1-20 g/m², the transparent base ink deposition should be 20-50 g/m² to generate a sufficiently thick wet film capable of receiving and retaining the colored/effect powder adhesive.

Additionally, the overlaid transparent base layer—primarily via its plasticizers once part of the cured film together with the retained powder adhesive—selectively plasticizes thermoplastic resins present in the paper coating during transfer to the textile substrate. This promotes non-transfer of the paper coating areas that are not part of the printed image.

The ingredients of the transparent base ink also contribute body, elasticity, and release to the image once transferred to the textile.

### Colored/Effect Powder Adhesive

The colored/effect powder adhesive (4) primarily facilitates the transfer of printed images on the transfer paper (1) to dark or light textile substrates of natural or synthetic fibers, such as cotton, linen, hemp, silk, wool, polyester, nylon, spandex, acrylics, and rayon. Additionally, it provides color, effects, adhesion, coverage, elasticity, wash resistance, and rub resistance to the transferred images on the textile substrate.

The colored/effect powder adhesive (4) comprises: hot-melt resins (20%-80% by weight); white hiding pigments (5%-50% by weight); blowing agents (1%-5% by weight); mineral fillers (1%-20% by weight); plasticizers (0.5%-20% by weight); thermoplastic resins (1%-20% by weight); and colored/special-effect pigments (3%-30% by weight).

Hot-melt resins are selected from ethylene-vinyl acetate, styrene-isoprene-styrene or styrene-butadiene-styrene block copolymers, low-density polyethylene, polyamides, ethylene-acrylic copolymers, polypropylene, phenoxy resins, polyesters, polyester-amides, polyurethanes, butyl rubber, polyvinyl acetate and copolymers, and paraffin waxes. These primarily promote transfer, elasticity, and adhesion of the image on the textile.

White hiding pigments are selected from titanium dioxide (rutile or anatase), zinc oxide, lithopone, zinc sulfide, and mixtures of barium sulfate and zinc sulfide, providing coverage and image on light or dark textiles.

Blowing agents are selected from hydrazines (e.g., 4,4′-oxybis(benzenesulfonyl hydrazide), 3,3′-disulfohydrazide diphenyl sulfone, trihydrazino triazine); semicarbazides (e.g., p-toluenesulfonyl semicarbazide); tetrazoles (e.g., phenyl tetrazoles); expandable polymeric microspheres; benzoxazines (e.g., isatoic anhydride); and azodicarbonamide.

Mineral fillers are selected from aluminum silicate (kaolin) calcined or hydrated, natural or synthetic calcium carbonate, talc, silicates, mica, fumed silica, microcrystalline silica, diatomaceous silica, and synthetic silicas, with average diameters between 5 and 20 μm.

Plasticizers include solids such as neopentyl glycol dibenzoate, glyceryl tribenzoate, and 1,4-cyclohexanedimethanol dibenzoate; and liquids such as dibutyl adipate, dibutoxyethyl adipate, di(2-ethylhexyl) adipate, di-isooctyl adipate, diisodecyl adipate, dibutyl sebacate, butyl benzyl adipate, dioctyl sebacate; citric esters such as triethyl citrate, tributyl citrate, acetyl tri-n-butyl citrate, acetyl tri-n-hexyl citrate; alkylsulfonic acid esters with phenols; benzoates such as propylene glycol dibenzoate and dipropylene glycol dibenzoate; terephthalates such as di-2-ethylhexyl terephthalate (DOTP); and trimellitates such as tri-2-ethylhexyl trimellitate (TOTM), tri-isooctyl trimellitate (TIOTM), and tri-isononyl trimellitate (TINTM).

Thermoplastic resins include polyvinyl chloride, polyurethane, acrylics, polyethylene, polypropylene, polyester, and polycarbonate.

Colored and special-effect pigments include organic pigments based on phthalocyanines and benzidines; pearlescents; glitter; phosphorescents; fluorescents; thermochromics; photochromics; and metallic pigments in various colors such as silver, gold, copper, etc.

### Digital Transfer Printing Method

The process comprises: (a) printing the image on the transfer paper (1) by means of a piezoelectric-head printer loaded with CMYK digital inkjet inks (2) and the transparent base ink (3). In a preferred mode, RIP software is used to manage the dose and mode of ink deposition. The image is printed mirror-reversed. As CMYK colors are printed, the transparent base ink (3) is deposited over that color layer, forming a translucent glossy layer covering the entire image area. The transparent base ink is also printed in the areas corresponding to white in the design; in those areas only the translucent transparent base is printed.
(b) Immediately upon exit from the printer, the colored/effect powder adhesive (4) is applied over the freshly printed wet image. A homogeneous coverage must be ensured so that the wet transparent base layer retains the powder adhesive. Excess powder outside the printed image is removed.
(c) The image coated with the colored/effect powder adhesive (4) is cured by applying heat in an oven or with a heat gun at 160-180 °C for 10-40 seconds. The white color and special effects in the image are obtained with the addition of the colored/effect powder adhesive.
(d) The transfer paper is placed with the printed image in direct contact with the target substrate and subjected to heat pressing at 150-200 °C for 10-20 seconds at a pressure of 2.1-6.3 kgf/cm² (30-90 lbf/in²).
(e) The garment or substrate is removed and allowed to cool completely.
(f) The transfer paper is peeled to reveal the image transferred to the substrate.

Optionally, after curing, the transfer paper can be stored for later transfer.

In one mode, in step (b), 15-20 seconds after applying the powder adhesive (4), powder that did not contact the image is removed—preferably by mechanical or manual vibration with the sheet vertical, or by vacuum with the sheet horizontal.

In another mode, in step (d) the transfer is carried out on a calender at 160 °C for 15 seconds at 4.2 kgf/cm².

The system and process are applicable to desktop printers (e.g., Epson L805, L8050) with at least six channels, where four channels are used for CMYK inks (2) and two channels for the transparent base ink (3). The system also applies to medium- and large-format roll printers in which some channels can be dedicated to CMYK and others to the transparent base ink; integrated printer-powder-applicator-curing-oven equipment can be used.

A higher proportion of transparent base ink relative to CMYK inks is required to exceed the absorption capacity of the paper and ensure retention of the colored/effect powder adhesive, which—through its ingredients—interacts with the paper components and the transparent base ink to enable image transfer to the textile substrate.

### Examples

The following non-limiting examples illustrate the invention.

Example 1: To obtain a sharply colored, covering image on a black cotton fabric, a coated transfer paper as described in CO-NC2019/0008859 was digitally printed using RIP software on a small-format Epson L805 desktop printer with four channels for CMYK inks (2) and two channels for the transparent base ink (3), at 1440×720 dpi. The transparent base ink comprised (by weight): deionized water 64.2%; 1,3-propanediol 10%; 1,6-hexanediol 10%; 2-amino-2-methyl-1-propanol 0.3%; methylisothiazolinone 0.1%; sorbitan monooleate PEG-20 (Tween 80) 1%; di- 2-ethylhexyl terephthalate (DOTP) 12%; di(2-ethylhexyl) adipate 2%; benzotriazole phenyl coumarin 0.2%; and 1-octyl-2-pyrrolidone 0.2%. CMYK deposition averaged 10 g/m² and the transparent base 30 g/m². The RIP was set so that both the CMYK-printed areas and the areas reserved for powder-adhesive color/effect were overlaid by a translucent glossy transparent base layer. Immediately after printing, a white powder adhesive (4) was manually spread onto the wet image; it contained: polyester-amide hot-melt resin 47.7% (particle size 10-80 μm; melt range 105-130 °C; melt index 25-30 g/10 min); azodicarbonamide blowing agent 0.3%; calcium carbonate filler (avg. 2 μm) 5%; glyceryl tribenzoate solid plasticizer 10%; rutile titanium dioxide 30%; and thermoplastic resin 7%. After 20 seconds, excess powder was removed by manual vibration with the sheet vertical. The image was then cured with a heat gun held 15 cm away, adjusted to reach 160-180 °C for 40 s. After 30 minutes, the black cotton fabric was placed in contact with the printed face of the transfer paper and heat-pressed at 6.3 kgf/cm² (90 lbf/in²) and 170 °C for 20 s. The fabric and paper were removed from the press, allowed to cool 5 minutes, and the paper peeled. A sharp, covering, soft-hand, elastic, and resistant image was obtained.

Example 2: To obtain fluorescent colors on a light-blue cotton fabric, a coated transfer paper as in CO-NC2019/0008859 was printed using RIP on a medium-format printer with one six-channel Epson TFP piezoelectric head at 7 m²/h and 360×1800 dpi, with four CMYK channels and two transparent-base channels. The printer was coupled to an automatic powder-application module that applies/sprays the adhesive, removes excess, thermosets, cools, and rewinds. The transparent base ink comprised (by weight): deionized water 58%; ethylene glycol 15.3%; triethanolamine 0.2%; methylisothiazolinone 0.1%; Tween 80 1%; acetyl tributyl citrate 25%; benzotriazole phenyl coumarin 0.2%; and 1-octyl-2-pyrrolidone 0.2%. CMYK deposition averaged 14 g/m² and the transparent base 35 g/m². Immediately after printing, a fluorescent pink powder adhesive was applied, excess removed, and thermoset at 160 °C. The adhesive comprised: polyurethane hot-melt 56.2%; azodicarbonamide 0.3%; kaolin filler 5%; neopentyl glycol dibenzoate solid plasticizer 1.5%; titanium dioxide (rutile) 10%; fluorescent pink pigment 20%; and PVC thermoplastic resin 7%. After 24 hours, transfer was performed on a Supra 170 calender at 5 m/min, 6.3 kgf/cm², and 170 °C. After cooling 10 minutes, the paper was peeled to reveal a digitally printed image with a novel fluorescent finish, vivid colors, sharpness, coverage, soft hand, elasticity, and resistance.

Example 3: To obtain pearlescent highlights with sharp, covering colors on a dark-blue fabric, coated transfer paper as in CO-NC2019/0008859 was printed using RIP on a small-format Epson L805 with a DX5 piezoelectric head at 1440×720 dpi, with four CMYK channels and one transparent-base channel. The transparent base ink composition matched Example 1. CMYK deposition averaged 8 g/m²; transparent base 35 g/m². Immediately after printing, a pearlescent powder adhesive was manually spread; it comprised: polyurethane hot-melt 73.9% (particle size 0.5-80 μm); azodicarbonamide 0.1%; fumed silica 2%; liquid plasticizer—dipropylene glycol dibenzoate—2%; pearlescent pigment 20% (particle size 15-150 μm); and acrylic thermoplastic resin 2%. After 20 s, excess was removed; the image was cured with a heat gun (160-180 °C, 40 s). After 30 minutes, the dark-blue fabric was heat-pressed at 6.3 kgf/cm² and 170 °C for 20 s, cooled 5 minutes, and the paper peeled, yielding a novel pearlescent image with coverage, soft hand, elasticity, and resistance.

In one mode, image transfer is applicable to other rigid or flexible substrates exhibiting thermoplastic affinity or porosity that permits anchoring by heat and pressure, such as wood, cardboard, or thermoplastic surfaces like synthetic leather, acrylic sheets, plastic containers, among others.

In another mode, the system can be used with desktop or medium/large-format printers featuring piezoelectric printheads such as Epson F1440, I3200-A1/I1600-A1, S3200-A1, S3200-A3, DX4, DX5, and DX7.

The colored/effect powder adhesive is preferably white; however, other colors and special effects—such as gold, silver, fluorescent, pearlescent, transparent, raised/relief, and migration-control agents—may be used. Unique effects and colors achievable only with the printing system and process disclosed herein.

### Advantages

The system described above provides the following technical effects:
CMYK inkjet inks and the transparent base do not clog printheads, allowing high print stability, high productivity, and cost savings.
Significant reduction of machine downtime due to piezoelectric printhead clogging.
Excellent color development and transfer without the need for cutting equipment.
Wide color gamut and excellent image resolution.
Versatility of use.
High-quality prints with excellent hand, resistance, and high definition.
Low environmental impact product, free from substances harmful to the environment and health.
Multiple special effects.
Coverage on light or dark textiles based on natural or synthetic fibers.
Adhesion to various substrates.
Improved elongation capacity.
Improved fastness and durability.
Color-migration control.
Ease of handling the technique enables high productivity.
Agility in garment customization.
Suitable for small or large-format printers.
Low initial investment for technique implementation.
High-productivity method for small and large runs.
Digital printing with small or large-format printers.
System applicable to a wide range of textile substrates.
Technological system with high levels of automation and production standardization.

1. A digital transfer printing system for substrates comprising: a transfer paper; digital inkjet printing inks; a transparent base ink; and a colored/effect powder adhesive, wherein the transfer paper includes a coating layer; wherein the paper receives CMYK pigment-type digital inkjet inks simultaneously with the printing of a transparent base ink, wherein the transparent base ink forms an overlaid wet layer over the entire image area; and wherein the wet layer subsequently receives the colored/effect powder adhesive which, upon heating, forms a cured film over the printed image for transfer to the substrate.

2. The digital transfer printing system of claim 1, wherein the order of deposition of the inks on the paper is managed such that both the image areas where the CMYK colors are printed and the areas of the same image not printed with CMYK—being reserved for the white color of the image or for areas whose color or effect is to be provided by the colored/effect powder adhesive according to the image design—are overlaid by the transparent base ink.

3. The digital transfer printing system of claim 1, wherein the substrates are light or dark textiles.

4. The digital transfer printing system of claim 1, wherein the transfer paper has a coated layer compatible with digital printing inks and comprising components such as water-soluble polymers, fillers, resins or thermoplastic polymers, binder polymers, release agents, and preservatives.

5. The digital transfer printing system of claim 1, wherein the digital inkjet printing inks comprise: deionized water between 20% and 80% with a maximum conductivity of 75 μS; organic pigments between 3% and 15% selected from phthalocyanines, quinacridones, monoazo pigments, diarylides, pyrazolones, disazo-condensation pigments, and polycyclic pigments—with dispersion particle size of one of <200 nm, and <80 nm; preservatives between 0.1% and 0.2% selected from chloromethylisothiazolinone derivatives; drying retarders between 5% and 30% selected from water-soluble materials including ethylene glycol; 1,3-propanediol; 1,4-butanediol; 1,4-cyclohexanedimethanol; 1,5-pentanediol; 1,6-hexanediol; 1,8-octanediol; 1,2-propanediol; propane-1,2,3-triol; 1,2-butanediol; 1,3-butanediol; 2,3-butanediol; diethylene glycol; triethylene glycol; tetraethylene glycol; polyethylene glycol of average molecular weight 200, 300, 400, 600, 900, 1000, 1500, and 2000; and humectants between 1% and 5% selected from ethoxylated acetylenic diols; sulfosuccinates; siloxane-based gemini surfactants; fluorinated surfactants;
organosilicones; and pyrrolidone-based surfactants (e.g., 1-octyl-2-pyrrolidone).

6. The digital transfer printing system of claim 1, wherein the transparent base ink is a colorless water-based ink comprising: deionized water between 20% and 80% by weight; drying retarder between 10% and 40% by weight; pH stabilizer between 0.5% and 4% by weight; preservatives between 0.1% and 3% by weight; emulsifiers between 0.5% and 4% by weight; humectants between 2% and 20% by weight; optical brightener between 0.5% and 3% by weight; and plasticizers between 5% and 40% by weight.

7. The digital transfer printing system of claim 1, wherein the deionized water of the transparent base ink has a maximum conductivity of 75 μS; wherein the drying retarders are selected from ethylene glycol; 1,3-propanediol; 1,4-butanediol; 1,4-cyclohexanedimethanol; 1,5-pentanediol; 1,6-hexanediol; 1,8-octanediol; 1,2-propanediol; propane-1,2,3-triol; 1,2-butanediol; 1,3-butanediol; 2,3-butanediol; diethylene glycol; triethylene glycol; tetraethylene glycol; and polyethylene glycols (Mw 200-2000); wherein the pH regulators are selected from sodium hydroxide, potassium hydroxide, sodium carbonate, sodium bicarbonate, triethanolamine, 2-amino-2-methyl-1-propanol, diethanolamine, and ethanolamine; wherein the preservatives are selected from chloromethylisothiazolinone derivatives; wherein the emulsifiers are selected from nonionic glycerol esters (glyceryl monostearate, glyceryl stearate citrate), fatty alcohol ethoxylates (e.g., laureth-10), poly glycerides, fatty acid alkanolamides (lauryl diethanolamide, oleyl diethanolamide), ethoxylated amines and amides, anionic emulsifiers (linear/branched sodium alkylbenzenesulfonates, linear/branched alkyl sulfates, linear/branched alkyl ethoxy sulfates), and sucrose fatty acid esters (sucrose polystearate); wherein the humectants are selected from ethoxylated acetylenic diols; sulfosuccinates; siloxane-based gemini surfactants; fluorinated surfactants; organosilicones; and pyrrolidone-based surfactants (1-octyl-2-pyrrolidone); and wherein the optical brighteners are selected from triazine-stilbenes (e.g., 4,4′-diamino-2,2′-stilbene disulfonic acid), coumarins (triazine phenyl coumarin, benzotriazole phenyl coumarin, naphthotriazole phenyl coumarin), bis-benzoxazoles, imidazolines, diazoles, triazoles, and biphenyl stilbenes.

8. The digital transfer printing system of claim 1, wherein the colored/effect powder adhesive comprises: hot-melt resins between 20% and 80% by weight; white hiding pigments between 5% and 50% by weight; blowing agents between 1% and 5% by weight; mineral fillers between 1% and 20% by weight; plasticizers between 0.5% and 20% by weight; thermoplastic resins between 1% and 20% by weight; and colored/special-effect pigments between 3% and 30% by weight.

9. The digital transfer printing system for substrates according to claim 1, wherein the hot-melt resins of the colored/effect powder adhesive are selected from the group consisting of ethylene-vinyl acetate polymers, styrene-isoprene-styrene or styrene-butadiene-styrene block copolymers, low-density polyethylene, polyamides, ethylene-acrylic copolymers, polypropylene, phenoxy resins, polyester, polyester-amide, polyurethanes, butyl rubber, polyvinyl acetate and its copolymers, and paraffin waxes; the white hiding pigments of the colored/effect powder adhesive are selected from the group consisting of titanium dioxide in its rutile and anatase crystalline forms, zinc oxide, lithopone, zinc sulfide, and mixtures of barium sulfate and zinc sulfide; the blowing agents of the colored/effect powder adhesive are selected from the group consisting of hydrazines such as 4,4′-oxybis(benzenesulfonylhydrazide), diphenylsulfone-3,3′-disulfohydrazide, trihydrazinotriazine; semicarbazides such as p-toluenesulfonyl semicarbazide; tetrazoles such as phenyl tetrazoles; expandable polymeric microspheres; benzoxazines such as isatoic anhydride; and azodicarbonamide; the mineral fillers of the colored/effect powder adhesive are selected from the group consisting of aluminum silicate (kaolin) calcined or hydrated, natural or synthetic calcium carbonate, talc, silicates, mica, fumed silica, microcrystalline silica, diatomaceous silica, and synthetic silicas, wherein the mineral fillers must have average diameters between 5 and 20 microns; the plasticizers of the colored/effect powder adhesive are selected from the group consisting of:
solids: neopentyl glycol dibenzoate, glyceryl tribenzoate, 1,4-cyclohexanedimethanol dibenzoate.
liquids: dibutyl adipate, dibutoxyethyl adipate, di(2-ethylhexyl)adipate, di-isooctyl adipate, diisodecyl adipate, dibutyl sebacate, butyl benzyl adipate, dioctyl sebacate; citric acid esters such as triethyl citrate, tributyl citrate, acetyl tri-n-butyl citrate, acetyl tri-n-hexyl citrate; alkylsulfonic acid esters with phenols; benzoates such as propylene glycol dibenzoate and dipropylene glycol dibenzoate; terephthalates such as di-2-ethylhexyl terephthalate trimellitates such as tri-2-ethylhexyl trimellitate, tri-isooctyl trimellitate, and tri-isononyl trimellitate;
the thermoplastic resins of the colored/effect powder adhesive are selected from the group consisting of polyvinyl chloride, acrylics, polyethylene, polypropylene, polyester, and polycarbonate; the colored and special-effect pigments of the colored/effect powder adhesive are selected from the group consisting of organic pigments based on phthalocyanines, benzidines, pearlescents, phosphorescents, fluorescents, metallic pigments (gold, silver, etc.), pearlescent pigments, and migration-control agents.

10. A digital transfer printing method for light or dark textile substrates, wherein it comprises the following steps:
a. Printing the image on the transfer paper by a piezoelectric-head printer loaded with CMYK digital inkjet inks and the transparent base ink.
b. once the printing exits the printer, applying the colored/effect powder adhesive onto the freshly printed wet image.
c. curing the image coated with the colored/effect powder adhesive by supplying heat in an oven or with a heat gun at 160 °C to 180 °C for 10 to 40 seconds. The white color of the image or special effect is obtained with the addition of the colored/effect powder adhesive.
d. placing the transfer paper from the previous step on the substrate to which the image will be transferred; and subjecting it to heat pressing at 150 °C to 200 °C for 10-20 seconds at a pressure of 2.1 to 6.3 kgf/cm² (30 to 90 lbf/in²).

11. The digital transfer printing method for light or dark textile substrates according to claim 10, wherein after step d, it further comprises:
e. removing the garment or substrate and allowing it to cool; and
f. peeling off the transfer paper to reveal the image transferred to the substrate.

12. The digital transfer printing method for light or dark textile substrates according to claim 10, wherein it includes raster image processor printing software that manages the amount and mode of ink deposition.

13. The digital transfer printing method for light or dark textile substrates according to claim 10, wherein in step a, the image is printed in mirror mode, wherein as the CMYK colors are printed, the transparent base ink is also printed, forming a translucent and glossy layer over the image, wherein the transparent base ink not only overlays the areas of the image printed with CMYK inks but is also printed in the areas corresponding to the white color of the image or reserved for their color or effect to be provided by the colored/effect powder adhesive according to the printed image design.

14. The digital transfer printing method for light or dark textile substrates according to claim 10, wherein in step b, the colored/effect powder adhesive is retained by the wet layer printed with transparent base ink, and once the colored/effect powder adhesive is applied, the excess is removed.

15. The digital transfer printing method for light or dark textile substrates according to claim 10, wherein in step b, between 15 and 20 seconds after applying the colored/effect powder adhesive, the adhesive that did not contact the image is removed by mechanical or manual vibration of the printed paper in a vertical position, or by suction with the paper in a horizontal position.

16. The digital transfer printing method for light or dark textile substrates according to claim 10, wherein in step d, the transfer paper from step c is placed on the substrate to which the image will be transferred, and subjected to heat pressing in a calender at 160 °C for 15 seconds at a pressure of 4.2 kgf/cm².

17. The digital transfer printing method for light or dark textile substrates according to claim 10, wherein in one embodiment, the piezoelectric-head printer has at least six ink channels, wherein four channels are dedicated to CMYK digital inkjet inks and two channels are dedicated to the transparent base ink.
